(19) United States
(12) Patent Application Publication
(10) Pub. No.: US 2009/0301943 A1
(43) Pub. Date: Dec. 10, 2009

(54) MUD-SCREEN USING 3-LAYERED SINTERED MESH

(76) Inventor: TODD BIGELOW, Langdon (CA)

Correspondence Address: Haynes and Boone, LLP;IP Section, 2323 Victory Avenue, SUITE 700, Dallas, TX, 75219, US

(21) Appl. No.: 12/135,878

(22) Filed: Jun. 9, 2008

(51) Int. Cl. B07B 1/49

(52) U.S. Cl. 209/399

(57) ABSTRACT

A screen for use in filtering drilling mud in a re-circulating system is provided by sintering multiple layers of metal cloth of graduated fineness, finest on top, to form a monolithic panel.

### FIELD OF THE INVENTION

The present invention relates generally to a type of multi-layered metal screen useful in removal of cuttings from drilling mud during recirculation while drilling. More particularly, the present invention relates to a mesh screen of layers of different screen fineness and coarseness and a novel method of bonding this particular screen's elements together.

### BACKGROUND OF THE INVENTION

In drill-rigs for drilling wellbores in the earth, it is common to use flowing mud as a drilling fluid to lubricate, clear cuttings, and even drive the bit during operations. The mud is circulated under pressure from surface downhole through a tubing string, past the cutting face at the bit, and up the annulus between the tubing and the wall of the well-bore. The fluid mud returns to the surface carrying cuttings/tailings from the drill-bit's operation. In order to re-cycle the mud for re-use in the operation, the cuttings/tailings debris must be removed from the mud.

This is accomplished by running the returned contaminated mud over a series of wire-mesh or similar screens, deployed over a mud collection system as a surface at an incline (“table”), approximately 4 feet wide and approximately 10 feet long. The mud, as it flows over the screens, flows through the openings in the screens, while the debris does not, but is caught on top of the table. The table is typically shaken or vibrated so as to cause the debris on top of the screen to move to the end of the table's course and be removed from the operation.

Typical shaker table screen panels are from 2′×4′ to about 4′×5′ in size, arranged in an array such that the shaker table's surface is about 4 feet wide and about 10 feet long. Different sized tables and screen panels are used by different manufacturers but these dimensions are useful for the purpose of describing this invention.

Typical shaker table screen panels are multi-layered, with a fine (200) mesh as the top layer, supported by a coarser (100) mesh middle layer and a much coarser (20) mesh bottom layer. (These screen sieve sizes are by way of example, different manufacturers using differing specific mesh sizes or screen openings; the screens need not be evenly woven wire mesh). The “filtering” effect of the screen is always done by the finer, top layer of the screen/mesh.

Fine screen/mesh is required to remove sufficient debris from the mud in order to re-use the mud without further treatment. The mud and debris is very abrasive and may contain large pieces of hard and sharp rock, and frequently tears the fine mesh, making the screen unusable. Torn screens are sometimes patched with silicon or other means, which blocks the openings in the mesh in the repaired part of the screen. Eventually, the rate of flow through the repaired screen panel is blocked by the effect of the repairs so as to become unusable.

Alternatively, multiple layers of screen have been bonded together using a matrix of plastic melted into the layers' mesh, holding the tearing to the size of the matrix (typically 1 inch×1 inch grid pattern up to 4 inch×4 inch grid pattern). The matrix itself blocks the openings in parts of the mesh, and the fine top layer of the mesh still tears. The tears are usually restricted to the size of the matrix open grid segments, which are then capable of being patched, with the result of eventually being blocked to suitable fluid flow prior to being worn out by abrasion.

Examples of prior patent art are:

US Application US2004/0251175A1 (Adams, et al.) describes a method of manufacturing a layers screen assembly, by spreading glue between two (or more) screens and then passing them through a set of rollers to bond the screens together.

US Application US2003/0042179A1 (Adams, et al.) describes a method of assembly of a screen for a vibration-separation process, entailing “sewing” two (or more) sheets of screening together into a single assembly.

U.S. Pat. No. 5,789,077 (Bakula) discloses a screen assembly first formed of two (or more) screen layers bonded together with a plastic bonding element, and then formed into an undulating pattern (a wave-form would be one way to describe an end-on view from the side which is perpendicular to the undulations or waves).

U.S. Pat. No. 6,601,709 B2 (Schulte et al), owned by Tuboscope in Houston, describes a screen and screen support for a shale shaker. The screen is formed of multiple layers of screen sheets, each successive layer of a finer grid, fused together with a melted plastic sheet in a grid pattern, with a perforated panel forming a screen support.

U.S. Pat. No. 6,669,985 B2 (Adams, et al) owned by Varco of Houston, discloses methods of manufacturing glued-together shale-shaker screens.

U.S. Pat. No. 7,000,777 B2 (Adams, et al) owned by Varco of Houston, discloses vibratory separator screens formed of multiple layers of screen materials assembled and sewn together.

U.S. Pat. No. 5,851,393 (Carr) owned by Emerson Electric of St. Louis, describes a screen assembly with layers including a screen layer, a support layer, and a grid layer, each having energy directors for ultrasonic bonding to the screen cloth.

U.S. Pat. No. 6,431,368 B1 (Carr) owned by Emerson Electric, discloses a multilayered screen with fusible material woven into certain of the screen layers, and the application of energy (heat) to fuse the layers of screen cloth together.

U.S. Pat. No. 6,283,302 B1 (Schulte, et al) owned by Tuboscope of Houston, discloses a unibody structure, essentially a two-sided fold-over sheet, which when folded, holds multiple layers of screen together.

U.S. Pat. No. 6,202,856 B1 (Carr) owned by Emerson Electric shows a multiple screen layered screen fixed with a fused “solidifying layer”.

It is, therefore, desirable to provide a mud screen manufactured of multiple layers of gradually finer meshed overlaid screen bonded in a way which overcomes or mitigates problems in the prior art.

### SUMMARY OF THE INVENTION

It is an object of the present invention to obviate or mitigate at least one disadvantage of previous prior art.

In a first aspect, the present invention provides a monolithic screen for use in filtering re-circulating drilling mud to remove cuttings, the screen being the result of sintering multiple layers of screen material of different fineness together.

In a further embodiment, there is provided a Method of a manufacture comprising the steps of:
a. assembling multiple screens in layers;
b. placing the layers screens in a press, until the screen layers are sintered into a monolithic sheet.

Other aspects and features of the present invention will become apparent to those ordinarily skilled in the art upon review of the following description of specific embodiments of the invention in conjunction with the accompanying figures.

A shaker table with mud-screen for removal of cuttings from re-circulating drilling fluid where the mud-screen is a monolithic screen made of a multiplicity of screen layers of differing mesh density, the top-most layer being the finest, where each layer is bonded to the adjacent layer at substantially every point where the wire of the mesh of a layer contacts the wire of the mesh of the adjacent layer when pressed together.

A monolithic screen for use in the removal of cuttings from re-circulating drilling fluid made of a multiplicity of screen layers of differing mesh density, the top-most layer being the finest, where each layer is bonded to the adjacent layer at substantially every point where the wire of the mesh of a layer contacts the wire of the mesh of the adjacent layer when pressed together

### BRIEF DESCRIPTION OF THE DRAWINGS

Embodiments of the present invention will now be described, by way of example only, with reference to the attached Figures, wherein:

FIG. 1 is a drawing of three graduated mesh cloth elements.

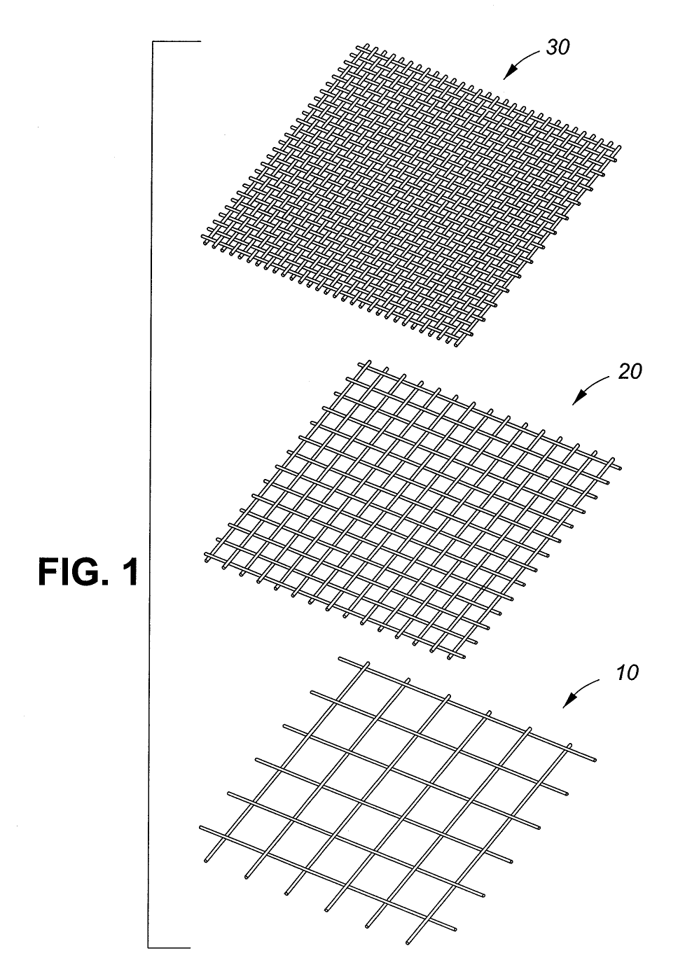

FIG. 2 is a drawing of a sintered screen.

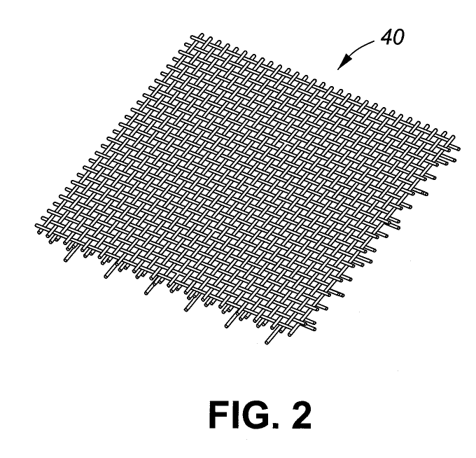

### DETAILED DESCRIPTION

Generally, this invention provides for two or more (preferably three) layers of metal mesh or screen to be bonded together by sintering the layers to each other wherever the meshes touch. This has the effect of restricting any ability of the top fine layer of mesh to tear to the hole-size of the next, supporting layer of mesh, which essentially stops the tearing. Further layers of mesh of larger opening-sizes may be bonded below that second layer to provide structural rigidity as required.

While sintered screens with multiple layers of metal cloth are known, for whatever reason they have not been manufactured or deployed as screen panels in a shaker-table of a drilling rig for the removal of debris from drilling fluids, and the configuration of graduated mesh fineness is also of import.

In the preceding description, for purposes of explanation, numerous details are set forth in order to provide a thorough understanding of the embodiments of the invention. However, it will be apparent to one skilled in the art that these specific details are not required in order to practice the invention.

A mud-shaker screen panel 40, one of several deployed in a mud-shaker table, is made of multiple layers of metal mesh 10, 20, 30, sintered under pressure and heat into one bonded screen. In a preferred embodiment, three screens of graduated fineness are sintered together such that each screen is bonded to each adjacent screen at essentially every point of contact of every mesh element between those adjacent screens, forming a monolithic screen structure.

There is thus no matrix of fused plastic or other extrinsic fastening involved, and the density of connections or bonds is such that:
(a) the bonds do not materially interfere with the screen's openings; and
(b) the finer meshed screens do not tear, as the ability for a tear to propagate is constrained by the multiplicity of bonds to the adjacent coarser screen(s).

The resultant screen 40 is monolithic, that is the previous layers, having been sintered together, are now of one piece of metal.

The metals used in mud-screens are typically stainless steel to resist the corrosive effects of the drilling fluids, such as 316L. Sintering takes place in specialized sintering equipment, placing the layers of mesh under conditions of high temperatures (to where the mesh metal softens sufficient for bonding), for example in the range of 500-1100 degrees Centigrade. The process also places the mesh layers under sufficient pressure that the layers, once softened, are pressed together to form consistent bonding wherever the wires in a layer touch the wires in the next layer.

The initial layers of mesh must be compatible in terms of being capable of being sintered together, and should be of similar melting and softening temperature points, and similar cooling times, in order that the sintering process does not cause one screen element to soften too much and deform or even anneal while another element has not yet softened sufficiently for sintering, and in order that during cooling no element cools at a significantly different rate as that might cause deformation cracking or loosening of sintered bonds.

There is no single optimum combination of mesh sizes for mud screens, as the screens used will be different depending upon drilling conditions. For instance, hard-rock drilling typically produces fine cuttings, which will require a screen with a finer surface mesh, and softer rock or shale will produce cuttings which can be large and sliver shaped, permitting the use of larger mesh openings in the mud-screen used. Smaller mesh openings will also cause slower fluid flow through the screen. Therefore, the choice of screen used in drilling operations will depend greatly upon the circumstances and environment in the borehole.

The mud screen needs to be of a large enough mesh to allow the drilling fluid to pass through and be recycled down the hole, but small enough to prevent cuttings from passing through the screen and so separated from the recycled fluid. The conductance or ease of fluid flow between the top and bottom of the screen is a consideration when choosing the density of mesh of a middle screen element, which has the function of reinforcing the top element and limiting the ability of the top element to tear to the space between mesh wires in the middle layer, when sintered together with the top layer. Too large an opening, and flow rates will be unimpaired but tear sizes will be intolerable and structural rigidity may be compromised by permitting the top layer to deform by, for instance, sagging into the holes in the middle layer. Too small an opening, and flow rates will be impaired.

Having said that, the mesh layer next beneath the upper mesh will typically have a mesh size about half as dense as the upper mesh, and a third or bottom layer would typically be chosen for its support characteristics to hold the screen in a single plane and not permit sagging or deformation which would affect the screening of debris from the drilling fluid.

In a preferred embodiment, the top layer, being the screening layer will typically have meshes in the range from 400-50 mesh. The middle layer, being a reinforcing layer for the top layer, will have mesh openings about 2 times that of the top layer, and so typically will be between 250-30 mesh. The bottom layer is meant for rigidity and to support the weight of the fluid under whatever flow-rates and pressures are desirable, the cuttings, and upper screens, and so typically will be between 30 and 8 mesh. Of course, consideration must be given to wire dimensions as well as hole dimensions when choosing an optimum set of screen layers for sintering and use as mud-screens.

The above description deals with square-woven wire mesh screens, but it will be obvious to one skilled in the art that woven wire mesh with oblong shaped holes or slotted screens or other types of screen panels might be sintered together in a monolithic structure and used as a mud-screen, and that the scope of this invention is meant to include those other variants and permutations of screen types. The metals used in the wire are preferably 316L stainless steel, or even plain steel wire can be used in the sintering process. Each adjacent screen must be of a metal compatible with the other adjacent screens and capable of being sintered by high pressure and temperature process.

The above-described embodiments of the invention are intended to be examples only. Alterations, modifications and variations can be effected to the particular embodiments by those of skill in the art without departing from the scope of the invention, which is defined solely by the claims appended hereto.

What is claimed is:

1. A shaker table with mud-screen for removal of cuttings from re-circulating drilling fluid where the mud-screen is a monolithic screen made of a multiplicity of screen layers of differing mesh density, the top-most layer being the finest, where each layer is bonded to the adjacent layer at substantially every point where the wire of the mesh of a layer contacts the wire of the mesh of the adjacent layer when pressed together.

2. The invention of claim 1 where the mud-screen is made of three screen layers, the top-most being the finest, the middle being of mesh about twice as coarse as the top-most, and the bottom-most layer being about 3-5 times coarser than the middle-most layer.

3. The invention of claim 1 where the mud-screen is of stainless steel mesh wire.

4. The invention of claim 1 where the mud-screen is of low-carbon steel mesh wire.

5. The invention of claim 1 where the mud-screen's top-most layer is in the range of 400-50 mesh

6. The invention of claim 2 where the middle-most layer is of 250-30 mesh.

7. The invention of claim 1 where the mud-screen's bottom-most layer is in the range of 30-8 mesh.

8. A monolithic screen for use in the removal of cuttings from re-circulating drilling fluid made of a multiplicity of screen layers of differing mesh density, the top-most layer being the finest, where each layer is bonded to the adjacent layer at substantially every point where the wire of the mesh of a layer contacts the wire of the mesh of the adjacent layer when pressed together
